(19) United States
(12) Patent Application Publication
(10) Pub. No.: US 2009/0255797 A1
(43) Pub. Date: Oct. 15, 2009

(54) APPARATUS FOR DESALINIZATION UTILIZINGTEMPERATURE GRADIENT/CONDENSATION AND METHOD THEREOF

(76) Inventor: David E. LONGER, Fayetteville, AR (US)

Correspondence Address: MCDERMOTT WILL & EMERY LLP, 600 13TH STREET, N.W., WASHINGTON, DC, 20005-3096, US

(21) Appl. No.: 12/414,076

(22) Filed: Mar. 30, 2009

Related U.S. Application Data
(60) Provisional application No. 61/040,569, filed on Mar. 28, 2008.

(51) Int. Cl. C02F 1/14

(52) U.S. Cl. 203/11; 202/166

(57) ABSTRACT

An apparatus and method for the desalinization of salt water utilizing a humidity chamber under partial vacuum and a water collection structure to collect fresh water product. Saltwater having a first temperature and cooling water contained in a condenser having a second temperature lower than the first temperature are introduced into the humidity chamber via a solar powered vacuum pump. A temperature gradient created by a difference in temperature between the saltwater and cooling water in combination with a partial vacuum (e.g., 10-20%) created by a solar powered vacuum pump is used to distill salt-free water from the saltwater with high efficiency. The temperature gradient is created in part by the use of a salinity gradient solar pond. The salt-free water is obtained by condensation of the water on a collection surface cooled by the cooling water followed by collection of the water in a storage apparatus.

### CROSS REFERENCE TO PROVISIONAL APPLICATION

This application is based upon and claims the benefit of priority from U.S. Provisional Patent Application No. 61/040,569 (Attorney Docket No. 081793-0011) filed on Mar. 28, 2008, the entire contents of which are incorporated by reference herein.

### FIELD OF DISCLOSURE

This disclosure relates to the field of salt-water purification via evaporative desalinization of salt water.

### BACKGROUND

Fresh water is a fundamental requirement for modern day societies. Without convenient access to fresh water, resources normally spent in day-to-day activities forwarding the progress of civilization are directed to acquiring water for basic survival. Regions without access to fresh water must either import water, a very costly endeavor, or develop methods to generate fresh water. One method of water generation is desalinization of salt water.

However, in order to provide enough fresh water for a medium to large size city, desalinization on a large scale must be performed. Large-scale desalination typically requires large amounts of energy as well as specialized, expensive infrastructure, making it very costly compared to the use of fresh water from rivers or groundwater. A number of factors determine the capital and operating costs for desalination: capacity and type of facility, location, feed water, labor, energy, financing and concentrate disposal. As such, one way to lower the cost of a desalinization plant is to utilize cheap and renewable power. In addition, an added benefit of renewable power is in lowering of environmental impact due to the lack of pollutant by-products during the generation of the power. Another method to lower cost is to ensure that the desalinization method is energy efficient and results in a high rate of conversion of salt water to fresh water product.

U.S. Pat. No. 6,607,639 described a system and method for desalinization featuring condensation of water. However, it does not disclose use of lowering pressure to allow for easier evaporation of saltwater, or the use of solar powered vacuum pumps to save fossil fuels.

### BRIEF SUMMARY

The present disclosure addresses the above mentioned problems with an apparatus for the desalinization of salt water utilizing a humidity chamber under partial vacuum and a water collection structure to collect fresh water product. Saltwater having a first temperature and cooling water contained in a condenser having a second temperature lower than the first temperature are introduced into the humidity chamber. A temperature gradient created by a difference in temperature between the saltwater and cooling water in combination with a partial vacuum (e.g., 10-20%) is used to distill salt-free water from the saltwater with high efficiency. The temperature gradient is created in part by the use of a salinity gradient solar pond which heats the salt water to be purified in an economic and pollution free manner. The salt-free water is obtained by condensation of the water on a collection surface cooled by the cooling water followed by collection of the water in a storage apparatus. The evaporation of the water is expedited by the use of a solar powered vacuum pump.

It is to be understood that the invention is not limited in its application to the details of the construction and arrangement of parts illustrated in the accompanying drawings. The invention is capable of other embodiments and of being practiced or carried out in a variety of ways. It further is to be understood that the phraseology and terminology employed herein are for the purpose of description and not of limitation.

One embodiment of the present disclosure implements a humidity chamber comprising a saltwater container providing saltwater at a first temperature; a cooling water condenser providing cooling water at a second temperature lower than the first temperature; and a fresh water collection structure. The temperature difference between the saltwater and the relatively cooler water creates a temperature gradient.

The humidity chamber of the inventive apparatus may comprise a rectangular box configuration having an interior and an exterior. A portion of the saltwater structure may be located along the interior bottom of the humidity chamber, while a portion of the cooling water structure may be located proximate to the interior top of the humidity chamber. A portion of the fresh water collection structure may be located between those portions of the saltwater structure and the cooling water structure found within the interior of the humidity chamber. It will be understood by those skilled in the art that the humidity chamber can assume various configurations including but not limited to a rectangular or a cylindrical configuration.

A linear relationship exists between the temperature gradient and the rate of condensation induced. The greater the difference between the temperature of the salt water and the temperature of the condensation surfaces in the humidity chamber, the higher the rate at which desalinated water will be produced. Accordingly, it is desirable to create as large a temperature gradient within the humidity chamber as is feasible.

An embodiment of the saltwater structure comprises a flat plat solar collector in a closed loop configuration with an insulated tank. Heating water which is within the closed loop is heated to a third temperature and stored within the insulated tank. The temperature of the heating water is relatively hotter than the saltwater's temperature. The heating water is applied to one or more heating coils located within the saltwater basin. Heat emitted from the heating coils will heat the saltwater to a desired temperature. This heated water can be utilized for heating the water to be purified either independently or in combination with other saltwater heating processes, such as thermal tubes. When used in combination, one heating apparatus maintains the temperature of the heated saltwater in the event the companion saltwater heating process is unable to provide adequate heat due to dark period, early morning hours or during periods of non-conducive periods.

In another embodiment of the present disclosure, a warm water heat exchanger in which water is heated to temperatures as high as 180-190° F. is used to raise the temperature of the salt water. The warm water heat exchanger supplies warm water from a salinity gradient solar pond. A salinity gradient solar pond generally is a body of water that collects and stores solar energy. The salinity gradient pond utilizes the relatively high density of saline over salt-free water to prevent the natural convection of solar heated water. The density of water increases with increasing concentration of salt. Typically, when water is heated, it becomes less dense and rises to the surface of the body of water. However, if the heated water is more dense than the layer of water above, the water will not rise. Accordingly, convection may be significantly reduced or eliminated by having layers of varying salinity.

A typical salinity gradient solar pond contains three layers: an upper surface layer is cold and is homogeneous with no or low salt content; the bottom layer is hot and homogeneous with a high salt content and therefore is dense and will not rise. The middle gradient layer has a salt content that increases with increasing depth of the pond. In the middle gradient layer, water cannot rise because water above it is lighter, and it cannot fall because the water beneath it is heavier. As a result, the stable gradient layer suppresses convection and acts as a transparent insulator, permitting sunlight to penetrate the upper two layers and heat the bottom layer as well as reducing heat loss from the bottom layer to the upper layer. The heat in the bottom layer can then be withdrawn by pumping the hot brine through an external heat exchanger or by pumping a heat transfer fluid, for example fresh water, through a heat exchanger placed on the bottom of the pond. Salinity gradient solar ponds have the potential to produce low cost thermal energy from a renewable source at large scale for industrial applications. This is due in part to the ability of salinity gradient solar pond to function as a heat storage device. Thus, the solar pond is capable of producing and retaining heat 24 hours per day throughout the summer and winter months.

As a result from the use of the salinity gradient solar pond, a temperature gradient of from 10 to 70° C. can result between the heated saltwater to be purified and the cooling water which is maintained at a temperature range over a period of time varying from 15 to 70° C. at low cost and low impact to the environment.

Adjusting the atmospheric pressure affects the boiling point of water. According to Boyle's law (V₁P₁/T₁=V₂P₂/T₂), by decreasing pressure, the boiling point of a liquid will be decreased under constant volume. Normally, the boiling point of water is 100° C. at atmospheric pressure (1 barr or 760 torr). A pressure of 0.25 barr (180 torr) is sufficient to lower the boiling point of water to 65° C. A pressure of 0.1 barr (76 torr) will lower the boiling point of water to 45° C.

In one embodiment of the present disclosure, the pressure of the humidity chamber is decreased by use of a solar powered vacuum pumping system. The solar powered vacuum pump is designed to move water through the closed loop hot and cold heat exchangers. The vacuum is created by the solar powered pumps by creating vacuum in a large cylinder during the day when the pumps receive energy to run, and then the vacuum is stored in the cylinder for night time operations of the water in the heat exchangers. Air is evacuated from the chamber such that the atmospheric pressure is reduced by 10-20%. This pressure lowering is sufficient to increase the rate at which water evaporates and condenses within the humidity chamber.

Oil sealed pumps and dry rotary pumps may be used in the solar powered vacuum pumping system of the present disclosure. In general, both types of pump rely on confining a volume of gas in a pumping chamber that is reduced in volume before exhausting on the high pressure side of the pump. Various geometric configurations are used in rotary vacuum pumps, including rotary vane pumps and interdigitated shapes rotating on parallel shafts.

Oil sealed rotary vane pumps comprise a single shaft driving a rotor with sliding vanes; the rotor and vanes rotate within an eccentric stator. The pump may have a single stage or may have two stages in series, with the larger first stage exhausting into a smaller secondary stage. The entire mechanism is immersed in oil for lubrication, sealing and cooling.

Known configurations of dry pumps include hook and claw, tongue and groove and screw geometries, and Roots pumps, among others. There is no oil in the dry pump mechanism; sealing is instead effected by close running clearances. While the use of oil sealed and dry rotary vacuum pumps are illustrated in this example, those skilled in the art will understand that other known vacuum pumps and methods or reducing the pressure within the humidity chamber are within the scope of this invention. One preferred embodiment is described as follows: Saltwater is fed into the humidity chamber via a saltwater intake line and collected in a salt water container located along the interior bottom of the humidity chamber. The interior bottom of the humidity chamber may be insulated. The saltwater is heated by warm water pumped into the humidity chamber from a warm water exchanger via a warm water intake line. The temperature of the heating water is relatively higher than the temperature of the salt water. The heat emitted from the heated water from the warm water exchanger will heat the saltwater to be purified to a desired temperature. The warm water heats the salt water, and then returns to the warm water exchanger via a warm water return line. As a result of the heating and reduced pressure present in the humidity chamber, the water evaporates into water vapor, leaving behind the other components of the salt water, mainly salt.

A cooling water condenser is located at the interior top of the humidity chamber. Cooling water is fed from a cool water exchanger into the condenser via a cool water intake line and returned to the cool water exchanger via a cool water return line. One aspect of the cooling water structure of the inventive apparatus comprises a cooling coil located within the humidity chamber and a cold water feed container located outside the humidity chamber which supplies cooling water to the cooling coil by a cold water feed tube. The cooling water is of a temperature sufficient to create a temperature gradient between the temperature of the heated water vapor and the atmosphere in the humidity chamber. As a result of the difference, the water vapor condenses to form desalinized water. A fresh water collection structure is located between those portions of the saltwater container and the cooling water condenser found within the interior of the humidity chamber. During operation of the apparatus, desalinated water is collected via condensation of the water and pumped to a fresh water collection chamber. After operation, the remaining concentrated brine left as a result of evaporation of the water from the salt water is pumped out of the salt water container via a brine concentrate return line.

One aspect of the fresh water collection structure of the inventive apparatus comprises one or more condensation sheets each of which has a fresh water collection trough. The salt-free water vapor forms as condensation as salt-free water droplets along the condensation sheets. These salt-free water droplets transfer by gravity to the collection trough. The salt-free water is then collected in a salt-free water storage container located outside the humidity chamber by a salt-free water feed tube.

### BRIEF DESCRIPTION OF THE DRAWINGS

FIG. 1 provides a schematic outline of an embodiment of a process for desalinization provided by the present disclosure.

FIG. 2 provides a schematic outline of an embodiment of a process for the heating of the saltwater as utilized in the inventive process of the present disclosure.

FIG. 3 provides a schematic of an additional embodiment of the process for the heating of the saltwater as utilized in the inventive process of the present disclosure.

FIG. 4 provides a schematic of an embodiment 150 to heat saltwater located within the saltwater basin.

FIG. 5 provides a perspective view of an embodiment of an apparatus for desalinization provided by the present disclosure.

FIG. 6 provides a perspective view of an embodiment of a saltwater structure provided by the present disclosure.

FIG. 7 provides a perspective view of an additional embodiment of a saltwater structure provided by the present disclosure.

FIG. 8 provides a perspective view of an embodiment of a cooling structure provided by the present disclosure.

FIG. 9 provides a cross-sectional view of an embodiment of salt-free water condensation and collection structure provided by the present disclosure.

FIG. 10 provides a side cross-sectional view of an embodiment of salt-free water condensation and collection structure provided by the present disclosure.

FIG. 11 provides a perspective view of an embodiment of a desalinization plant according to the present disclosure.

FIG. 12 provides a side view of an embodiment of the solar powered vacuum pump system controlling the water level in the water tank.

### DETAILED DESCRIPTION

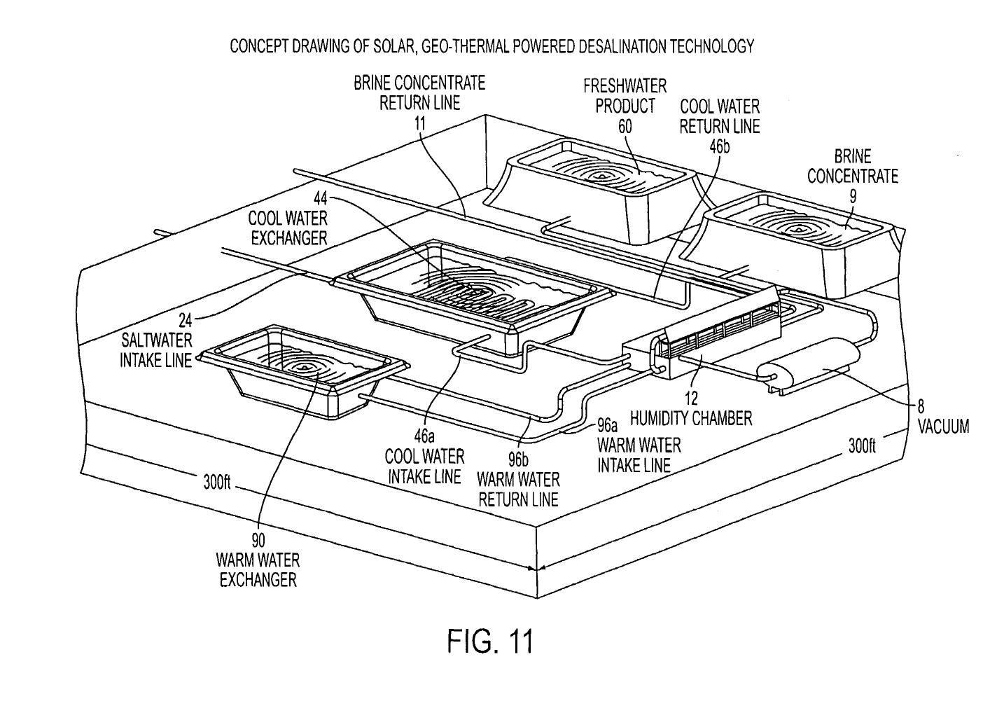

FIG. 11 illustrates the general desalinization operation of one embodiment of the present disclosure. Saltwater is fed into the humidity chamber 12 via a saltwater intake line 24. The saltwater is heated by warm water pumped into the humidity chamber 12 from a warm water exchanger 90 via a warm water intake line 96a. The temperature of the heating water is relatively higher than the temperature of the salt water. The heat emitted from the heated water from the warm water exchanger will heat the saltwater to be purified to a desired temperature. The warm water heats the salt water, and then returns to the warm water exchanger 90 via a warm water return line 96b. Vacuum pump 8 evacuates air from the humidity chamber 12 such that the pressure in the humidity chamber 12 is reduced allowing for more efficient evaporation of water. As a result of the heating and reduced pressure present in the humidity chamber 12, the water evaporates into water vapor, leaving behind the other components of the salt water, mainly by salt.

Cooling water is fed from a cool water exchanger 44 into the humidity chamber 12 via a cool water intake line 46a and returned to the cool water exchanger 12 via a cool water return line 6. The cooling water is of a temperature sufficient to create a temperature gradient between the temperature of the heated water vapor and the atmosphere in the humidity chamber 12. As a result of the difference, the water vapor condenses to form desalinized water. During operation of the apparatus, desalinated water is collected via condensation of the water and pumped to a fresh water product collector 60. After operation, the remaining concentrated brine left as a result of evaporation of the water from the salt water is pumped out of the humidity chamber 12 to be stored in a brine concentrate collector 9 before removed via the brine concentrate return line 11.

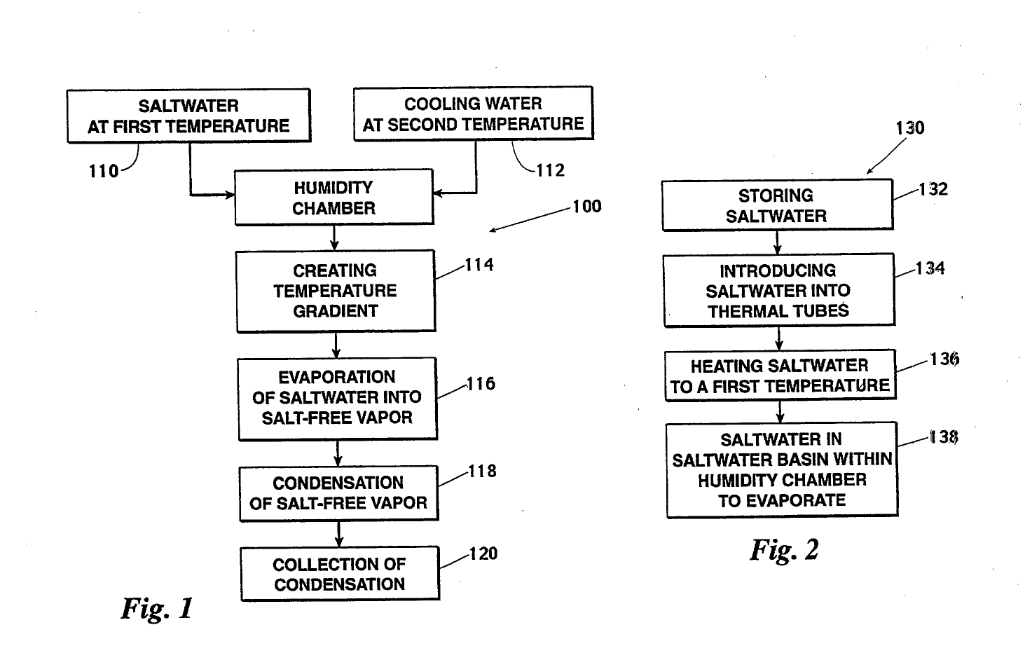

FIG. 1 illustrates a schematic of an embodiment 100 of the process of the present disclosure. Embodiment 100 comprises introducing saltwater having a first temperature and cooling water having a second temperature, which is cooler than the first temperature of the saltwater, into a humidity chamber as illustrated in steps 110 and 112. The temperature difference creates a temperature gradient which establishes an atmosphere suitable for the evaporation of saltwater as illustrated in steps 114 and 116. When the saltwater is evaporated, the salt-free water molecules separate as salt-free water vapor from the salt-related constituent compounds; The salt-free water vapor then condenses as droplets on a salt-free water collection structure as illustrated in step 118. The salt-free water droplets are then collected as illustrated in 120.

FIG. 2 illustrates a schematic of an embodiment 130 of the process for the heating of the saltwater as utilized in a process of the present disclosure. Embodiment 130 comprises storing saltwater in a saltwater storage container, as illustrated in step 132, then introducing the saltwater into a series of thermal tubes, as illustrated in step 134. The saltwater is then heated to a first temperature and then introduced into a saltwater basin located within the humidity chamber, as illustrated in steps 136 and 138, where it will then evaporate.

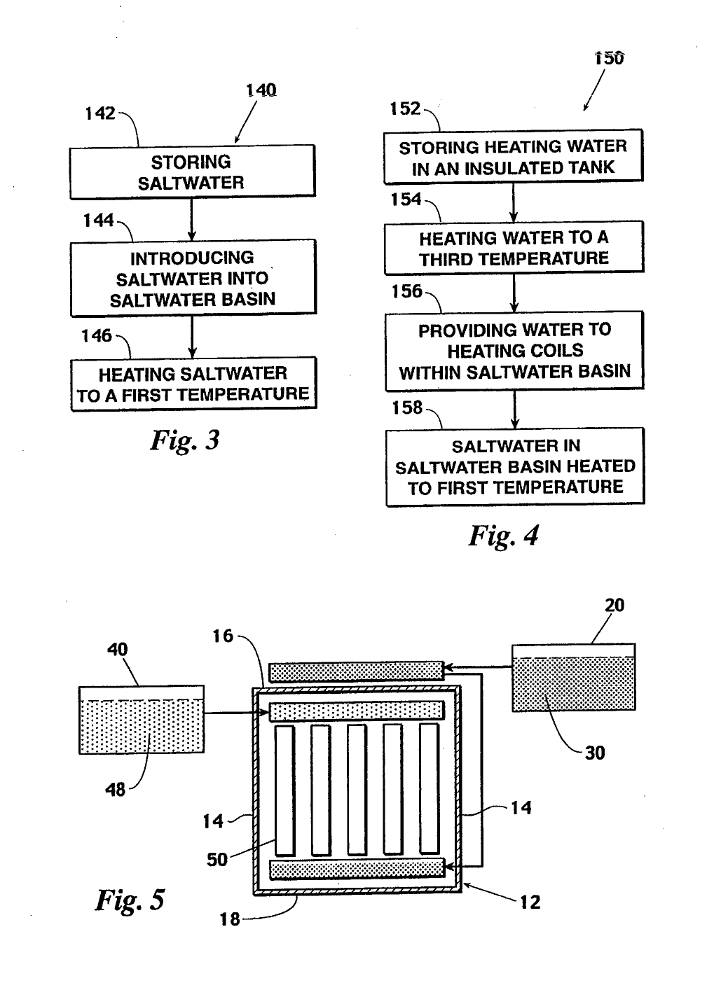

FIG. 3 illustrates a schematic of an additional embodiment 140 of the process for the heating of the saltwater as utilized in a process of the present disclosure. Embodiment 140 comprises introducing saltwater from a saltwater storage container into a saltwater basin located within the humidity as illustrated in steps 142 and 144. The saltwater is then heated to a first temperature by way of a closed loop heated water assembly as illustrated by step 146.

FIG. 4 illustrates a schematic of an embodiment 150 to heat saltwater located within the saltwater basin. As illustrated in steps 152 and 154, water is heated by a flat plate solar collector and stored in an insulated tank or obtained from a salinity gradient solar pond. The heated water is then released in to heating coils located within the saltwater basin residing in the humidity chamber, as illustrated in steps 156. The saltwater located within the saltwater basin is then heated via the heated water to an acceptable temperature for evaporation as illustrated in steps 158. While the close loop heating process is illustrated as being used independently, those skilled in the art will recognize that this process can be used in combination with other heating processes, such as the thermal tube heating process.

As shown in FIG. 5, an embodiment 10 of the apparatus comprises a humidity chamber 12, a saltwater container 20, a cooling water container 40 and a salt-free water collecting container 50. Saltwater container 20 provides saltwater 30 having a first temperature into humidity chamber 12. Cooling water container 40 provides cooling water 48 having a second temperature, which is relatively cooler than the temperature of the saltwater, into humidity chamber 12. The temperature difference between saltwater 30 and cold water 48 creates a temperature gradient which establishes suitable atmospheric conditions for the evaporation of the saltwater. During this evaporation process, salt-free water evaporates into water vapor while the salt and salt-related constituent compounds do not. The salt-free water vapor then condenses on salt-free water condensing and collection container 50. The salt-free water condensation is then collected for later use.

Humidity chamber 12 is shown in a general rectangular box configuration having a top 16 a bottom 18 and four side walls 14. While humidity chamber 12 is shown in a generally rectangular configuration, those skilled in the art will understand that such configuration is for illustrative purposes and other various configurations, including, but not limited to a cylindrical configuration, can be utilized and is within the scope of this invention.

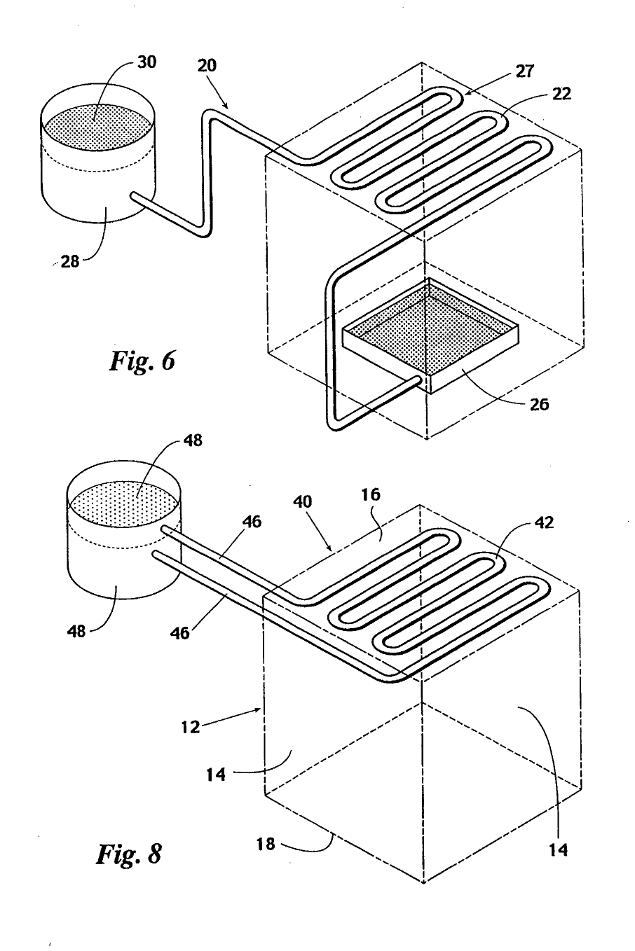

As shown in FIG. 6, one embodiment of saltwater container as comprising a thermal tube apparatus 27 having a saltwater feed container 28 located outside of the humidity chamber 12, a saltwater basin 26 located within the humidity chamber 12 and one or more thermal tubes 22 which can be located atop humidity chamber 12, each of which are connected by various portions of saltwater feed tube 24. Thermal tubes 22 can be made of any material which can heat saltwater to a sufficient first temperature, such as but not limited to plastic or aluminum. While thermal tubes 22 are illustrated atop humidity chamber 12, those skilled in the art will understand that thermal tubes 22 could be located at some other location still stay within the scope of this invention.

Saltwater 30 is stored within saltwater feed container 28. It is then provided to thermal tubes 22 through a portion of saltwater feed tube 24 where it is heated to a first temperature. After it has been heated, saltwater 30 is then provided into saltwater basin 26 to await evaporation once sufficient atmospheric conditions are created.

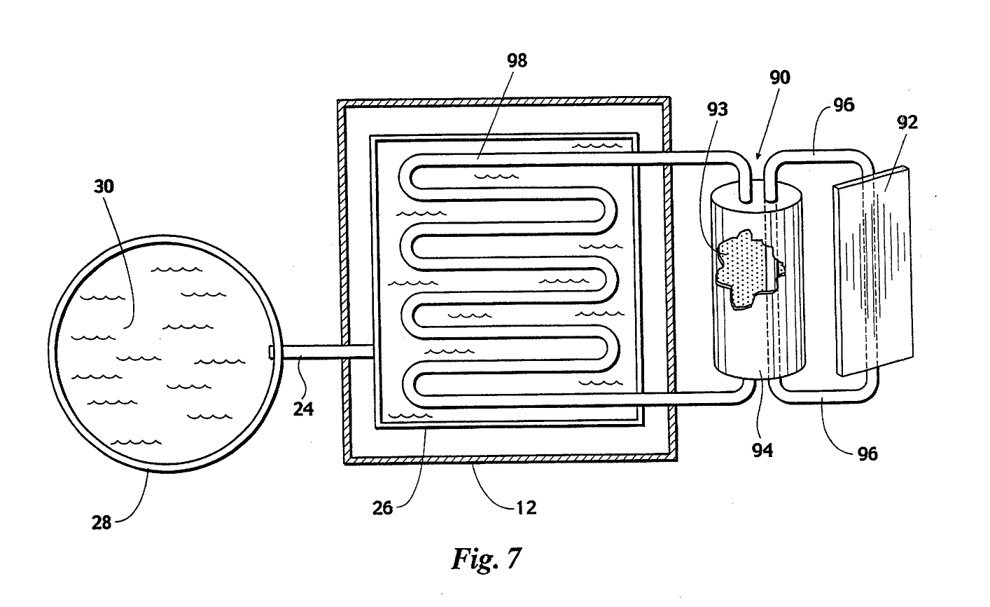

As shown in FIG. 7, another embodiment of saltwater container 20 comprises a saltwater feed container 28 located outside of the humidity chamber 12, a saltwater basin 26 located within the humidity chamber 12, each of which are connected by various portions of saltwater feed tube 24, and water heating structure 90. Water heating structure 90 comprises a flat plate solar collector 92 in communication with an insulated tank 94 via a series of heat tubes 96 in a closed loop. One or more heat coils 98 resides within saltwater basin 26. Heating water 93 is stored in insulated tank 94 and is heated by solar collector 92. As heating water 93 flows through heat coils 98, the saltwater 30 which is located within saltwater basin 26 is heated.

Another embodiment of saltwater container involves the incorporation of both the thermal tubes apparatus 27 and the water heating structure 90. The thermal tube apparatus 27 is configured and used as set out above. The water heating structure 90 heats and stores heating water 93 in the insulated tank 94 as set out above. During dark periods or extended periods without sunlight, the temperature of saltwater 30 drops. To keep this temperature at an acceptable level, water heating structure 90, through the use of a thermostat controlled valve, circulates heating water 93 through heat coils 98.

As shown in FIG. 8, one embodiment of cooling container 40 comprises a cooling coil 42 located proximate to the top 16 of humidity chamber 12. A cold water feed container 44 provides cold water 48 through the cooling coil 42 through cold water feed tube 46. Cold water 48 has a second temperature which is less than the temperature of saltwater 30, the difference between which creates a temperature gradient.

Cooling coil 42 is generally shown in a general switchback configuration. However, to those skilled in the art, various other configurations are within the scope and spirit of this invention. Additionally, cold water feed tube 46 and saltwater feed tube 24 can be made from any suitable material such as but not limited to copper piping.

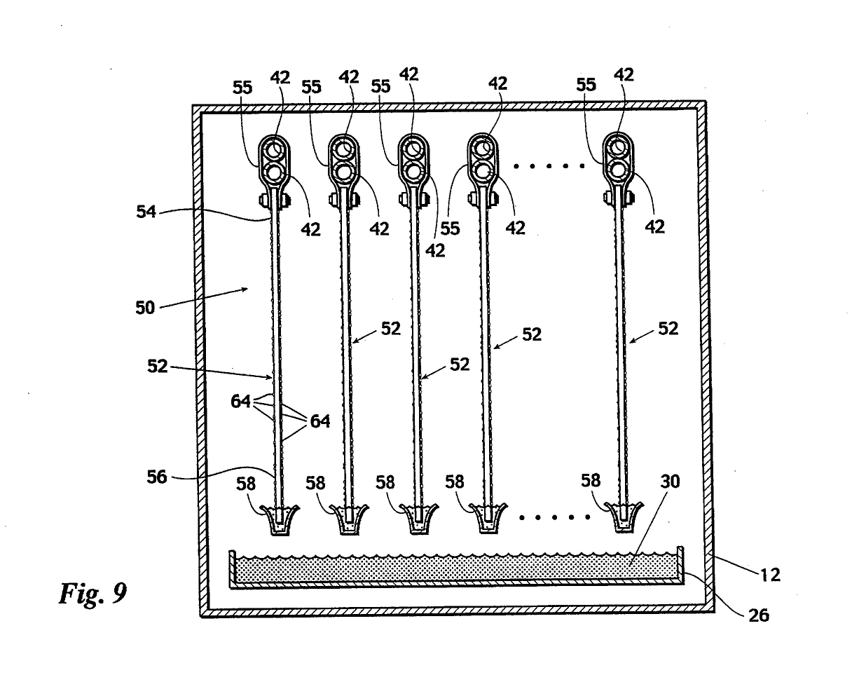

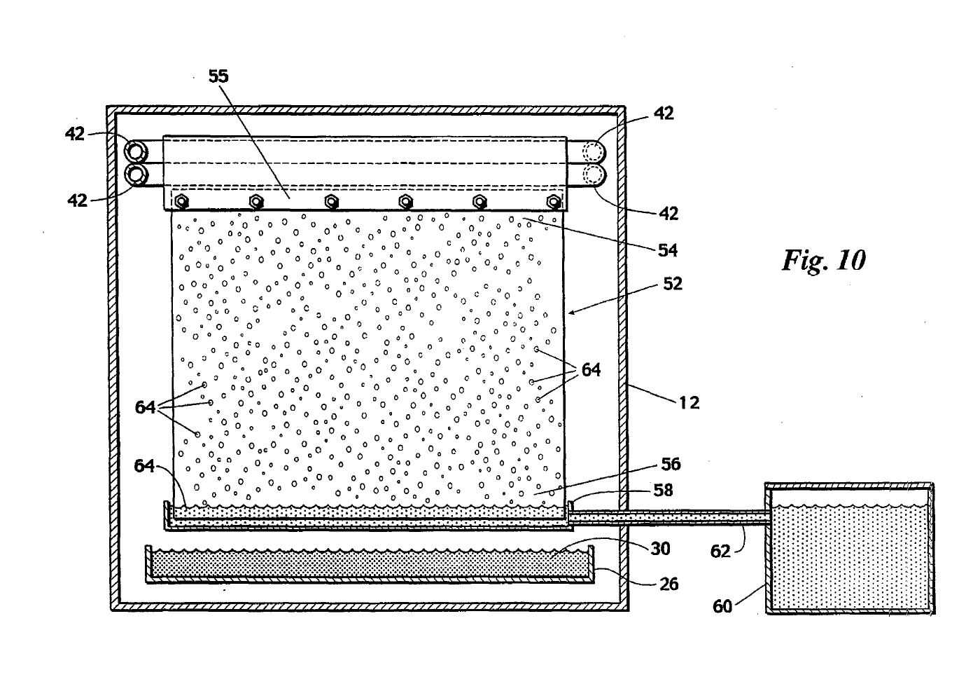

As shown in FIGS. 9 and 10, one embodiment of salt-free water condensation and collection container 50 is illustrated and- comprises a condensation sheet 52 located within humidity chamber 12 between saltwater basin 26 and cooling coil 42. The portion of condensation sheet 52 proximate to cooling coil 42 is referred herein as upper portion 54. The portion of condensation sheet 52 proximate to saltwater basin 26 is referred herein as lower portion 56.

Upper portion 54 is secured to cooling coil 42 by way of a transfer sheet 55. Transfer sheet 55 can be made from any suitable material. One preferred material is, but not limited to, copper. While the use of transfer sheet 55 is illustrated to connect upper portion 54 to cooling coil 42, those skilled in the art will understand that other known connection devices and methods are within the scope of this invention.

Due to the varying temperatures within the chamber 12, the salt-free water vapor will condense on condensation sheet 52 as salt-free water droplets 64 which cascade down into salt-free water collection trough 58 which is secured to lower portion 56 of condensation sheet 52. The collected salt-free water 64 is then provided into salt-free water collection basin 60 by way of salt-free water collection tube 62.

As is shown in FIG. 9, the present disclosure may utilize a single collection sheet 52, or multiple collection sheets and collection troughs 58 may be utilized.

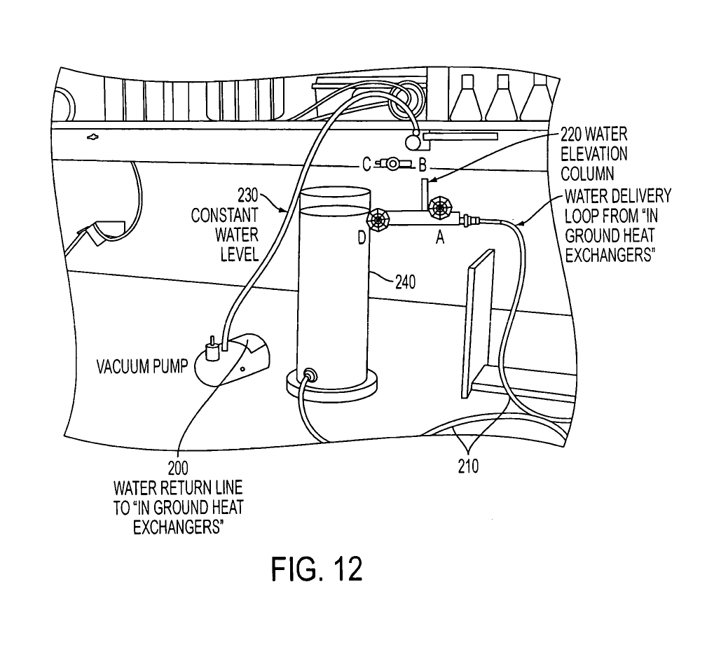

The operation of one embodiment of the solar powered pump 200 is described in FIG. 12. Instead of stored vacuum in a cylinder, a solar powered vacuum pump is used. The brown tubing represents one closed loop heat exchanger 210 and the water throughout the system is maintained at a constant water level in the water tank 240. To operate the system, Valve A and Valve B are opened and Valve C and Valve D are closed. Valve A admits water into the water elevation column 220 which then rises because Valve B is opened to the vacuum chamber and the vacuum pump 200, and the reduced air pressure in the column relative to ambient pressure causes the water 230 to rise. Once the rise reaches a maximum level, Valve A and Valve B are closed and Valve C and Valve D are opened. Valve C admits outside air returning the air pressure in the water elevation column 220 to ambient and the water in the water elevation column 220 flows through Valve D and into the water tank 240 and ultimately the feed end of the closed loop heat exchanger 210. Only a small fraction of the stored vacuum energy is used during each cycle, so pumping large amounts of water through the heat exchanger system can be accomplished 24 hours per day. Moreover, as the pump only uses solar energy, no power will be required from grid electricity or fossil fuels for pumping purposes.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

What is claimed is:

1. A process for the desalinization of saltwater comprising the steps of:
introducing saltwater having a first temperature into a humidity chamber comprising, storing saltwater in a saltwater feed container;
introducing said saltwater having said first temperature to a saltwater container located within said humidity chamber;
heating said saltwater to said first temperature comprising;
storing heating water in a salinity gradient solar pond;
heating said heating water to a third temperature through the use solar energy;
introducing said heating water to at least one heating coils located within said saltwater container thereby heating said saltwater to said first temperature;
introducing cooling water having a second temperature into said humidity chamber,
wherein the difference between said first temperature and said second temperature creates a temperature gradient which causes evaporation of said saltwater during which salt-free water molecules evaporates into water vapor and separate from the salt and salt-related constituent compounds contained within said saltwater;
providing a surface to allow said salt-free water vapor to form a condensed salt free water; and collecting said condensed salt-free water,
wherein said humidity chamber is kept at a pressure of from about 5% to about 30% lower than atmospheric pressure.

2. The process of claim 1, wherein said third temperature is from about 150 to about 190° F.

3. The process of claim 1, further comprising the step of: maintaining said temperature gradient at substantially the same temperature.

4. The process of claim 1, further comprising the step of: maintaining said temperature gradient between a range of 10 and 70° C.

5. The process of claim 1, wherein the pressure of the humidity chamber is maintained by use of a solar powered vacuum pump.

6. A desalinization apparatus comprising:
a humidity chamber comprising:
a salt water container for containing a source of saltwater to be desalinated;
a condenser having with a cooling coil equipped with cooling water intake line for condensing the salt-free water;
a salt-free water collection structure for collecting the condensed salt-free water;
a warm water exchanger for heating the salt water to be desalinated with warm water;
a warm water intake line connecting the warm water exchanger and the saltwater container for supplying the warm water to heat the saltwater;
a warm water return line connecting the warm water exchanger and the saltwater container for returning the warm water after heating the saltwater;
a cool water exchanger for cooling the cooling water;
a cool water intake line connecting the cool water exchanger and the cooling coil for supplying the cooling water to the cooling coil;
a cool water return line connecting the cool water exchanger and the cooling coil for returning the cooling water to the cool water exchanger; and
a vacuum pump connected to the humidity chamber for reducing the pressure in the humidity chamber.

7. The desalinization apparatus of claim 6, wherein
said vacuum pump is powered by solar power.
